(19) United States
(12) Patent Application Publication
(10) Pub. No.: US 2012/0259711 A1
(43) Pub. Date: Oct. 11, 2012

(54) METHODS AND SYSTEMS FOR MERCHANT-CENTRIC PROMOTION GENERATION AND TARGETED PUBLISHING

(76) Inventor: Benjamin Jabbawy, Newton, MA (US)

(21) Appl. No.: 13/441,069

(22) Filed: Apr. 6, 2012

Related U.S. Application Data
(60) Provisional application No. 61/473,512, filed on Apr. 8, 2011.

(51) Int. Cl. G06Q 30/02

(52) U.S. Cl. 705/14.72

(57) ABSTRACT

A platform and methodology facilitates the design, execution and tracking of Internet-based retail promotions by the merchant offering the promotion. An integrated set of promotion tools (collectively, a platform) are provided to merchants that allow the merchant to create virtually any type of promotion, with any restrictions, limitations and level of discount as determined by the merchant. The promotion is distributed using any specified distribution channel or channels to any desired segment of consumers. The consumers may then “purchase” the promotion or otherwise interact with the merchant either on line or in-store.

### CROSS-REFERENCE TO RELATED APPLICATIONS

This application claims priority to and the benefit of U.S. provisional patent application with Ser. No. 61/473,512, filed on Apr. 8, 2011, entitled “Methods and Systems for Merchant-Centric Promotion Generation and Targeted Publishing.”

### TECHNICAL FIELD

This invention relates generally to the offer and sale of promoted goods and services, and, more specifically, to a system and methods for offering promotions of such goods and services on a network, such as the Internet.

### BACKGROUND

In a typical retail transaction, consumer and merchants interact with little or no negotiation with respect to the terms of a sale or purchase of a good or service. Accordingly, it is not unusual for the merchant to offer special sale conditions or discounts on a promotional basis. The promotions may be generally available (e.g., time-bound sales), special access for preferred customers, or some combination of the two.

Promotions are an integral marketing strategy for many vendors of goods and services. Vendors rely upon discounts and other special offerings for a variety of reasons, such as to garner interest in new and existing goods and services, to increase the sales of a particular item or service, re-engage existing customers and/or to increase the sales of the merchant's other goods and services. Further, consumers seek out promotions for many reasons such as, but not limited to, a way to reduce their costs while trying out new businesses or broaden their exposure of goods and services from businesses they already know and enjoy.

Coupons and rebates are types of promotions that have typically been distributed using direct mail, newspapers, magazines, and other printed materials though these methods have often been considered inefficient due to the frequently low percentage of quality users (defined as high potential to achieve the desired lifetime value of a particular consumer specified by a company) who actually receive and use the coupons as well as difficulty in tracking redemption rates. Besides not being environmentally friendly due to paper waste, coupons and rebates distributed using the aforementioned methods are usually not cost effective due to the distribution volume required to generate meaningful results.

Rebates, another retail promotional tactic, have also been noted to have historically small percentages of consumer redemption and, more importantly, have been notoriously difficult to track and analyze with accuracy. The same drawbacks apply to coupons. Advertising and marketing through traditional media, such as print, radio, television, etc., can be both expensive and ineffective with large amounts of wasted spending (in the form of inefficient advertising purchases) and offer fulfillment for poorly targeted consumers.

The above conditions have led to a rise in Internet-based marketing wherein a consumer-facing third-party guarantees a deep discount if a specified minimum number of consumers commit to buy the offer (known typically, but not exclusively, as group commerce and/or daily deals). These platforms make a commitment to consumers first, then “up-sell” an established consumer audience to merchants. There is, however, indication that these discount offers sites often result in negative consumer sentiment towards the merchant due to, but not limited to, poor communication of policy, inconsistent execution across merchants and unrealistic expectations regarding what consumers are entitled to. The negative sentiment can be largely attributed to the lack of direct communication between the merchant and the consumer before redemption of the offer. Additionally, merchants (and especially their employees) can develop scorn for low quality “deal-seeking” consumers who try to take advantage of the deep discounts promised by the third-party with no intent to return to the merchant. Moreover, the depth of discount required by the third-party to participate in said programs can be detrimental to best business practices and can, on occasion, lead to a business-ending loss.

Therefore, there is a clear need for new, merchant-centric promotion-generation and publishing methods that better align with the needs/interests of business owners and allow for the merchant to more directly reward and communicate with a higher quality consumer base.

### SUMMARY OF THE INVENTION

The systems and techniques described herein provide a platform and methodology that facilitates the design, execution and tracking of Internet-based retail promotions in a manner that addresses the various shortcomings of conventional approaches. In general, an integrated set of promotion tools (collectively, a platform) are provided to merchants that allow the merchant to create virtually any type of promotion, with any restrictions, limitations and level of discount as determined by best practices and intent for that specific merchant. The promotion may then be distributed using any specified distribution channel or channels to any desired segment of consumers. The consumers may then “purchase” the promotion or otherwise interact with the merchant either on line or in-store.

Therefore, in a first aspect, a computer-implemented method for delivering an offer to a consumer includes providing electronic access to a promotions server on which computer-executable instructions are stored, that, when executed, allow a merchant to design and distribute an offer to consumers. In such implementations, designing the offer includes selecting, by the merchant, certain offer parameters and offer delivery outlets. Distributing the offer includes effecting the transmission of the offer to consumers and receiving an acceptance of the offer from some of the consumers.

In certain embodiments, the offer may be a discount on a consumer good or a service. The offer parameters may include a time frame during which the offer is available, the product or service being offered, the price(s) for which it is offered, the location the offer may be redeemed, the audience to whom the offer will be presented, or any combination of the foregoing. In some versions, the offer parameters are automatically generated based, at least in part, on historical offers. The historical offers may have been designed by the same merchant offering the current offer, or in some cases, a collection of other merchants who offered the same or similar offers in the past and/or have some relevant similarity to said merchant. The merchant may accept or modify one or more of the automatically generated offer parameters prior to distributing the offer. Upon receipt of a consumer's acceptance of the offer, the merchant can fulfill the offer and transmit confirmation of the acceptance to the consumers that accepted the offer.

In another aspect, a system for delivering an offer to a consumer includes a processor for executing computer-executable instructions and a memory for storing computer-executable instructions, that when executed by the processor, provides access to a promotions server on which a merchant designs and distributes an offer to consumers. Designing the offer includes having the merchant select offer parameters and delivery outlets and distributing the offer includes transmitting the offer to consumers and receiving acceptances of the offer from the consumers.

In some embodiments, the computer-readable instructions further implement a feedback module that, when executed, automatically generate some of the offer parameters, therefore suggesting parameters for the merchant to include in the offer. A data storage module may be used to store offer parameters of historical offers, and the instructions may use the stored data to automatically generate the offer parameters. The historical offers may have been designed by the same merchant offering the current offer, or in some cases, a collection of other merchants who offered the same or similar offers in the past, or in other cases, have been designed in computer-readable terms to be similar to the merchant. The merchant may accept or modify one or more of the automatically generated offer parameters prior to distributing the offer. Upon receipt of a consumer's acceptance of the offer, the merchant can fulfill the offer and transmit confirmation of the acceptance to the consumers that accepted the offer.

In another aspect, the invention provides software in computer-readable form for performing the methods described herein.

### BRIEF DESCRIPTION OF DRAWINGS

In the drawings, like reference characters generally refer to the same elements throughout the different views. Also, the drawings are not necessarily to scale, emphasis instead generally being placed upon illustrating the principles of the invention.

FIG. 1 is a block diagram of an environment in which the systems and techniques described herein may be implemented according to various embodiments of the invention.

FIG. 2 is a flow chart depicting, in summary, a process for designing and delivering an online promotion in accordance with various embodiments of the invention.

FIG. 3 is a flow chart depicting a process for approving, distributing and tracking the results of a promotion in accordance with one embodiment of the invention.

FIG. 4 is a flow chart depicting a process for tracking and analyzing the results of a promotion in accordance with one embodiment of the invention.

FIG. 5 is a flow chart depicting a process for validating and redeeming an online promotion in accordance with one embodiment of the invention.

FIG. 6 is an illustration of one embodiment of the invention as implemented across a distributed network such as the Internet.

FIG. 7 is a schematic illustration of a computer storage and processing device on which various embodiments of the invention may operate.

### DETAILED DESCRIPTION

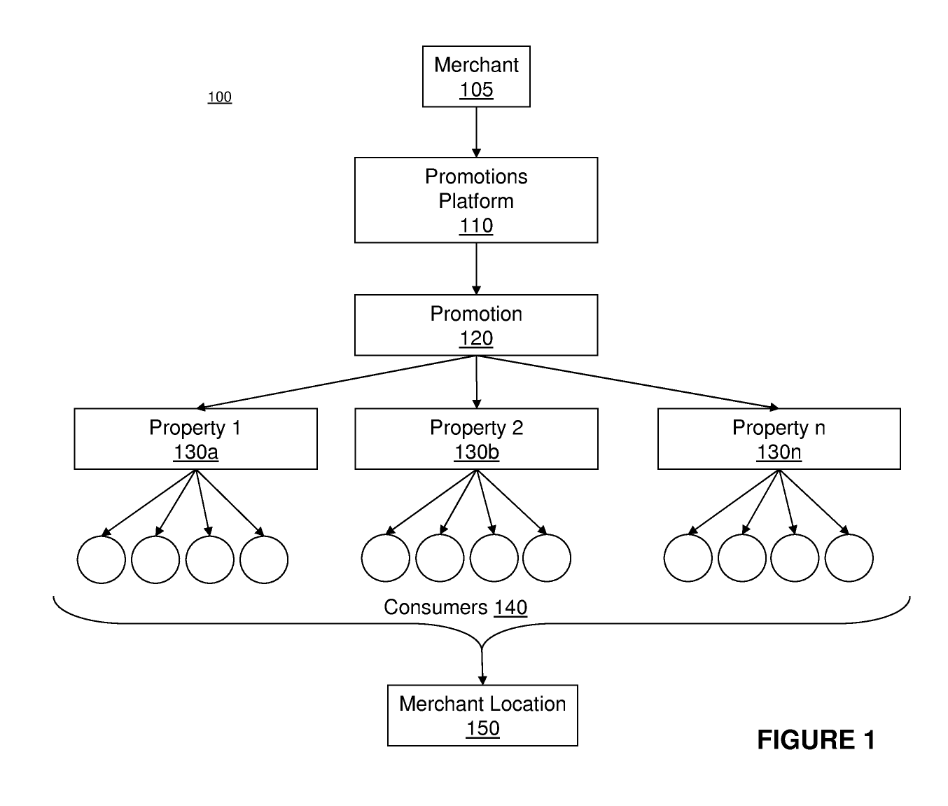

Referring to FIG. 1, in one embodiment, merchants, consumers and the systems and methods described herein operate in an online retail marketplace 100. In general, one or more merchants 105 access an online promotions development, execution and analysis platform 110. The platform includes a collection of tools and functions that allow the merchant 105 to design their own unique advertising promotions 120 while taking advantage of historical data related to other similar promotions. The promotions 120 may be distributed using one or more different properties 130a, 130b . . . 130n (generally 130). Each property 130 may be a specific online content channel (e.g., CNN, Boston.com, ESPN etc.), a messaging property (e.g., GMAIL, SMS Messaging), a social network platform (Facebook, Twitter, etc.), traditional media such as television and radio (both public broadcast and subscription-based) and/or signage such as billboards, placards, etc. The promotions reach individual consumers 140, who may act on the promotion by printing out a coupon, purchasing a discounted item, etc. and bring or submit the promotion to the merchant's point of sale location 150 for redemption. The point of sale may be a physical storefront or, in some cases, an website.

The promotions may be highly customized by and for each merchant 105. In fact, because the platform 100 places the functionality of designing and delivering the promotion directly in the hands of the merchant, she can tailor each promotion to target very specific sets of consumers 140. For example, a proprietor of a yoga studio may want to increase her student base, but recognizes that a single “one size fits all” promotion is not optimal. Therefore, she decides to develop three different promotions—one targeting existing students that practice multiple times a week, a second promotion targeting students that have not attended a class in over six months, and a third promotion that targeting new students. Unlike conventional group-buy sites, the platform 100 permits the studio owner to selectively target and track each of the three promotions and utilize data from prior promotions to determine promotion parameters such as price, duration, product offering, etc.

In one embodiment and continuing with the example described above, the studio owner's website is enabled to offer discounts and communicate with a centralized promotions server. For example, the studio owner may install a component or module (for example, a JavaScript module) onto her website. The studio owner then selects the goods to discount, specifies any discount conditions and provides the discount offer to her student base and/or the general public. Upon acceptance by a consumer, a message is sent to the studio owner's website confirming the student's acceptance of the discount offer. For example, the confirmation may include a link to a web location, the link being characterized by consumer identifier and a discount offer identifier. The student then accesses a web location through a link, obtains a validation of discount redemption and receives a right to obtain the discount. The validation of discount redemption may include receiving an enabling component or predetermined identifier (such as a code or key), which is automatically generated and provided by the platform. In some implementations, as the offers are being accepted, contact information is collected for each consumer and upon completion the information is compiled and sent to the studio owner. The compilation may occur at the studio owner's website or at a remote server.

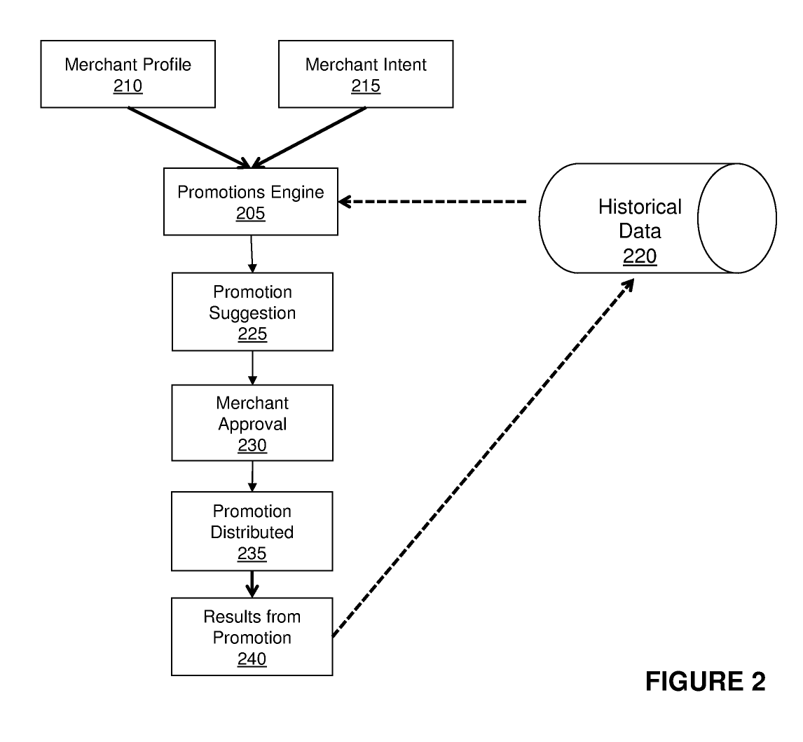

Referring now to FIG. 2, the platform includes a promotion engine 205 that suggests one or more promotions to a merchant based on their merchant profile 210, any intentions 215 related to the merchant's business, and system-gathered, relevant historic data 220. In some embodiments, an online, web-based dashboard presents the merchant with a screens and forms that walks the merchant through the use of the promotion engine 205. The merchant profile 210 may include geographic data, schedule data, color schemes, text and other attributes associated with the merchant's brand. Merchant profile 210 may also include product information such as average price point, vertical markets, inventory, most commonly sold item, etc. The intentions 215 information may include desired dates for the promotion, products, pricing information, demographics for consumers, desired outcomes (e.g., customer acquisition, customer loyalty or product liquidation). The historical data 220 may include parameters of prior promotions for the merchant (and in some cases other merchants) and the results of the promotions. The promotions engine 205 generates one or more promotion suggestions 225. The suggestions 225 are promotions that include programmatically-derived parameters that define the details of what the promotion offers and to whom it will be sent. If the merchant agrees with the design of the promotion, she can approve the promotion or modify the promotion to her acceptance 230 and it is distributed to the desired audience 235. As consumers redeem their promotions, the results are captured in the database 220 to help design subsequent promotions.

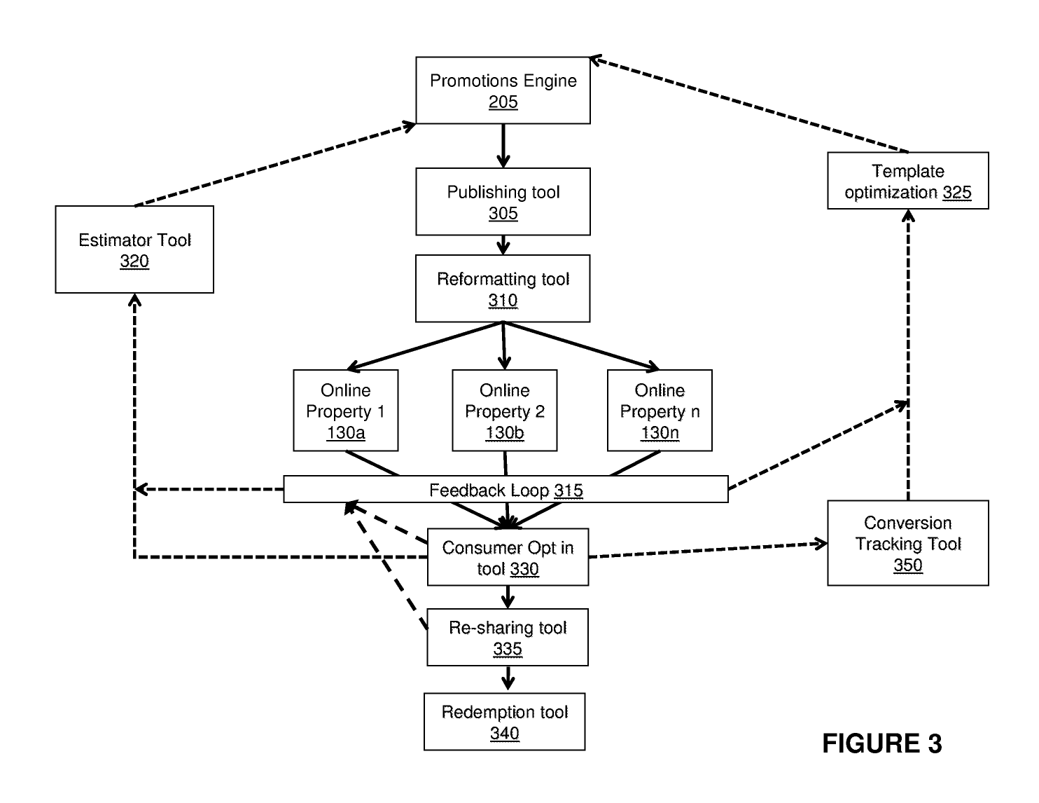

Referring to FIG. 3, once the merchant has used the promotion engine 205 to generate a promotion or, alternatively, has created her own custom promotion, she can utilize a publishing tool 305 to distribute the promotion using a set of specified distribution channels 130a, 130b . . . 130n. The publishing tool 305 syndicates distribution to a series of channels in a single click as they are identified and/or approved by the merchant. Some of these channels may include, but are by no means limited to, the merchant's website, the merchant's Facebook page, the merchant's Twitter stream, the merchant's email database, a targeted banner ad campaign, outdoor digital billboards, online radio, terrestrial radio, etc. All channels approved by the merchant qualify as suitable distribution options for any and all promotions created on the platform. The merchant can activate or deactivate any of the distribution options as she sees fit.

Once the merchant has determined to which destinations she would like to publish a promotion, a reformatting tool 310 may be used to automatically reformat the content of the promotion to fit best practices for the destination. This may include, but is by no means limited to, a widget on a website, a Facebook application, a composed Tweet or a composed email. The merchant may change the look, tone, or format of the promotion for any online destination at any time to keep up with best practices, changes in formatting standards, new channels, or any other reason.

In some cases, the publishing tool 305 requests access to certain platforms or other website properties that may not be owned by a merchant, such as, but not limited to, a website, Facebook page or twitter stream. By gaining access to these outlets, the platform facilitates syndicated publishing of a promotion created or approved by a merchant. The publishing tool 305 may republish a promotion at any frequency, with the consent of the participating merchant, as is deemed beneficial to the merchant. One purpose of republishing a promotion is to increase the number of quality consumers who may opt-in for an offer, which in turn increases the number of consumers who take advantage of the promotion and patronize the merchant's store.

In some implementations, a separate feedback loop 315 is used to track key performance indicators of each promotion. These indicators may include open rate, purchase rate, redemption rate, average price point, etc. The collection, aggregation and normalization of these metrics provides the merchant with insights into the performance of each promotion, and identifies top performing promotion suggestions for future merchant promotions. Any and all of the performance indicators are automatically tracked and compiled into reports which are sent to the merchant for the purposes of demonstrating the success of the promotion and offering suggestions to improve performance over time, as well as others. The improvement suggestions may be generated manually or by an auto-generated program (e.g., an algorithm) that tracks key performance indicators against standards that are considered successful so as to automatically generate such suggestions in a timely and efficient manner. The standards may be for that particular merchant, or, in some cases an aggregated and anonymized collection of metrics across many merchants. In some instances, the collection across multiple merchants is culled to include only those with a similar profile (market, geography, etc.) as the merchant using the data. This also enables the system to optimize the promotions engine and future promotions suggestions to new and existing merchants over time.

Additionally, the metrics are collected into a centralized database. The database is used by the promotion engine to automatically suggest best practice promotions across all merchants in the network. By constantly updating the database with metrics from recent promotions, the promotions engine uses the most relevant data available, thus providing the most relevant and meaningful promotion suggestions to the merchants.

In some implementations, a conversion tracking tool 350 uses a variety of the collected metrics to track and determine the elasticity of certain promotion suggestions on some or all outlet properties 130. To do so, the system track tracks key performance indicators, such as, but not limited to, the rate of consumers that view that specific promotion suggestion as compared to the number of consumers that ultimately purchase that promotion suggestion. If a merchant chooses to modify certain elements of that promotion suggestion such as price, the system will check previous conversion data for the modified promotion suggestion to estimate the implications of that modification. In such cases, the metrics from individual promotions and the results of the conversion tracking tool 350 provides input for an estimator tool 320, which provides the merchant with an estimate on what impact any changes to the promotion parameters are implemented. As a result, the merchant has a better understanding of how changes to price, audience, timing, product mix or other aspects of the promotion will influence its performance. Using the yoga studio example above, the studio owner may want to see the impact of lowering the cost of a monthly pass from $35 to $25. While this may positively impact the number of purchases, it may do so to such an extent that the studio may be over capacity. Therefore, she may opt to leave the price at $35 and receive less revenue, but maintain the quality of her clients' experience.

Separately from the merchant's experience in creating and distributing the promotion, as described above, consumers may opt-in or out via an opt-in tool 330 to qualify for promotions. Methods of opting-in may vary but in all instances there will be an exchange of input from the consumer for rights to redeem a promotion from the merchant. Methods may include offering personal information such as an email address or phone number, credit card information, or any other information that may be requested by the merchant. In some instances, the merchant may request some form or amount of payment in exchange for the goods or services that comprise the promotion. When the consumer submits his information, the information is sent to a centralized server and categorized against the specific merchant for which it was submitted, and made available for subsequent promotions by that merchant.

In some instances, the platform facilitates the sharing of promotions via social networks, email and other similar means using a resharing tool 335. Foe example, once a consumer has indicated he wishes to accept, purchase and/or redeem a promotion, the resharing tool 335 queries the central database to determine if the merchant has approved any pre-existing perks in exchange for the consumer sharing the promotion with their social network or email contacts. The pre-existing perks can include a deeper discount, an additional product or service, funds towards a future promotion, etc. If the merchant has approved an additional perk, the consumer is prompted to share the promotion in exchange for the additional perk. Once the promotion is shared, the resharing tool 335 connects with the tracking tool 350 and opt-in tool 330 to update the promotion as being accepted and shared by the consumer. The consumer then receives an email regarding the newly adjusted promotion. If the consumer chooses to not reshare, then the opt-in tool processes promotion and no additional perk is granted.

When a consumer has opted-in to receive a promotion, he receives a notification (electronically or otherwise) from a redemption tool 340, on behalf of the offering merchant, that they have qualified for the promotion. In order to redeem the promotion, the consumer may a) print the notification to show to the merchant upon redemption or b) visit an online page which has been generated for that specific consumer for that specific promotion. The consumer may be directed to that online page through a unique link that has been generated for the specific promotion for which that consumer has specifically opted-in. In some cases, the page includes a validation system to verify that the consumer did in fact submit the information requested by the merchant in exchange for the promotion and has previously redeemed the promotion more than a pre-specified number of times allowed by the merchant (in most cases, one). The consumer may redeem the promotion in-store using a paper coupon, or electronically using a mobile phone or tablet device application using, for example, a bar code or QR code generated specifically for the promotion and the consumer. The redemption tool 340 may also include a unique identification code that the merchant enters to approve or decline the status of the redemption as is appropriate.

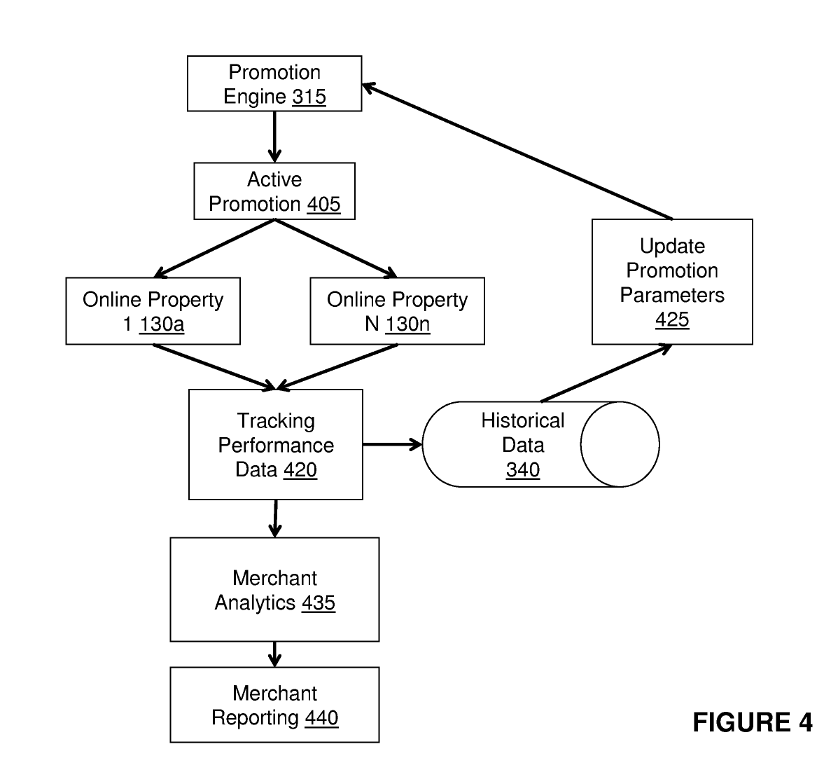

FIG. 4 illustrates an additional process flow for providing feedback and data analytics to the merchants. Once the promotion engine 315 initiates an active promotion 405 and it is approved by the merchant, it is distributed via one or more online properties 130. As consumers purchase, share, comment on, or otherwise interact with the promotion tracking and performance data 420 is generated. The data may indicate, for example, how many consumers opened an email, shared a link on a social network, tweeted the promotion to their followers, etc. The data may be transmitted to historical database 340 for subsequent use in generating suggested promotions. In some cases in which promotions last for a period of time (e.g., multiple days or weeks), the promotion data may be used to update parameters of the current promotion 425. The data may then be organized by merchant, promotion and other parameters using a merchant analytics tool 435. The analytics tool may function as a centrally-hosted application that the merchants access via the Web, or, in other instances, it may be a downloadable application operating on a personal computer, mobile or tablet device. The data may be formatted and organized into standard reports 440 and/or provided in a format that facilitates custom reporting formats.

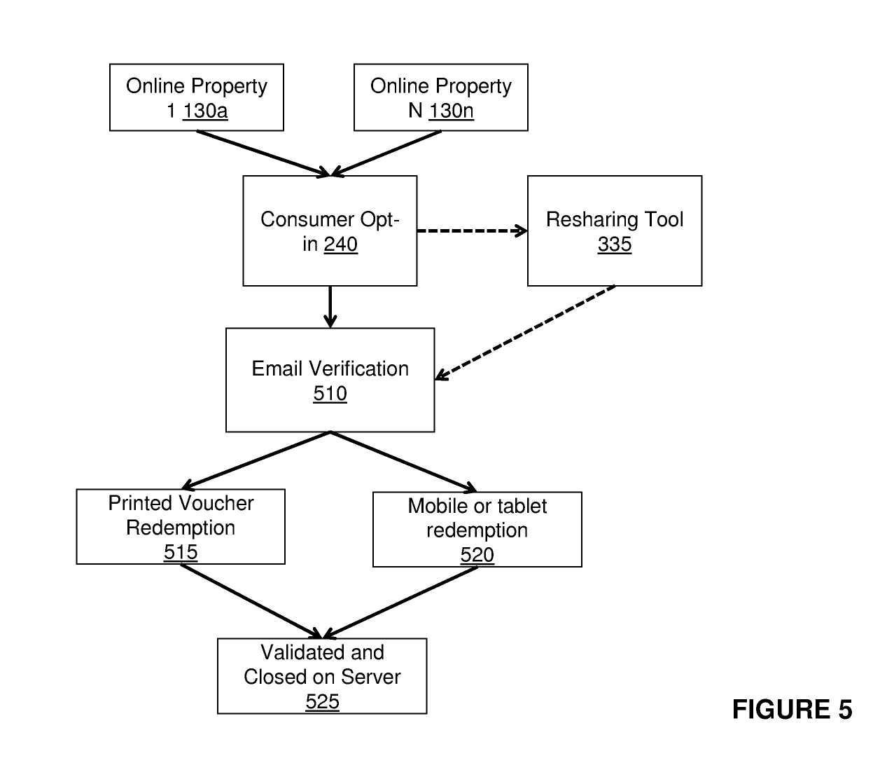

FIG. 5 illustrates the process by which a consumer receives, purchases and redeems a promotion. The consumer subscribes to or otherwise uses one or more online platforms 130 for receiving communications and interacting with other parties such as email, newsfeeds, web pages, social networks, etc. If the consumer has affirmatively opted into receiving promotions from the merchant using the opt-in process 240, he receives a verification 510 (via email, text or otherwise) that he has accepted the promotion. Prior to receiving verification 510, the consumer can reshare the promotion using the resharing tool 335 which, if leveraged, will change the discount confirmed via verification 510. The consumer may then print out a voucher 515 or receive an electronic receipt 520 on his mobile or tablet device, either of which may be used to redeem the promotion. During the redemption process, the consumer's purchase is validated and marked as redeemed 525 on the central server.

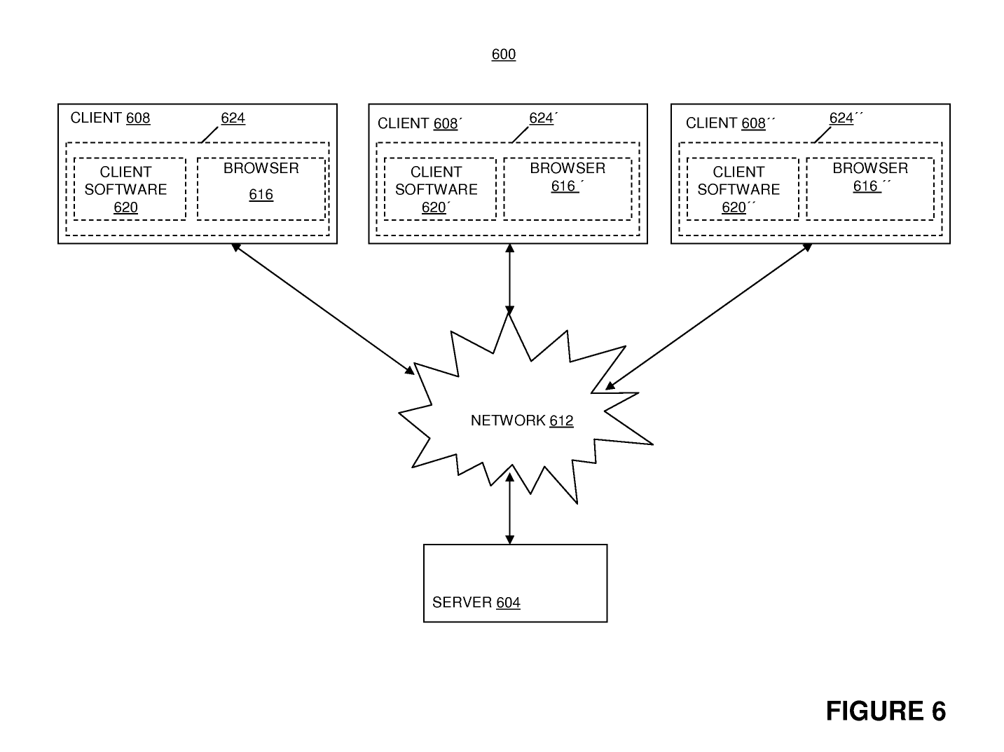

Referring now to FIG. 6, in one embodiment, an online promotion development and execution system 600 includes at least one server 604, and interacts with and provides its services and functions to at least one client device 608, 608′, 608″, generally 608. As shown, the platform interacts with three clients 608, 608′, 608″, but this is exemplary and for demonstrative purposes, and it is intended that there can be any number of clients 608. The client 608 may be implemented as software running on a personal computer (e.g., a PC with an INTEL processor or an APPLE MACINTOSH) capable of running such operating systems as the MICROSOFT WINDOWS family of operating systems from Microsoft Corporation of Redmond, Wash., the MAC OS operating system from Apple Computer of Cupertino, Calif., and various varieties of Unix, such as SUN SOLARIS from SUN MICROSYSTEMS, and GNU/Linux from RED HAT, INC. of Durham, N.C. (and others). The client 608 may also be implemented on such hardware devices as a smart or dumb terminal, a point of sale device (POS), network computer, set top box, game player, mobile device, wireless device, wireless telephone, personal digital assistant, media (e.g., music and/or video) player, camera, information appliance, workstation, minicomputer, mainframe computer, or any other device with computing functionality. The client 608 may be operated as a general purpose computer or a special purpose hardware device.

Generally, in various embodiments, clients 608 may be operated by one or more merchants and used to provide input and instructions to the promotion platform. Examples of promotion development activities include but are not limited to determining the products and services that will be promoted, the economic parameters of the promotion, the timing of the promotion, the consumers to whom the promotion will be offered, tracking the results of the promotion, as well as others. Clients 608 may be operated by individuals acting on behalf of the merchant (e.g., employees or third-party marketing consultants) or the individual merchant herself.

In some embodiments, a client device 608 includes a web browser 616, client software 620, or both. The web browser 616 allows the client 608 to request a web page or other downloadable program, applet, or document (e.g., from the server 604) with a web page request. One example of a web page is a data file that includes computer-executable or interpretable information, graphics, sound, text, and/or video, that can be displayed, executed, played, processed, streamed, and/or stored and that can contain links, or pointers, to other web pages. In one embodiment, a user of the client 608 manually requests a web page from the server 604. Alternatively, in another embodiment, the client 608 automatically makes requests with the web browser 616. Examples of commercially available web browser software 616 are INTERNET EXPLORER, offered by Microsoft Corporation, CHROME, offered by Google Corporation, SAFARI, offered by Apple Corporation, or FIREFOX offered by the Mozilla Foundation.

In some embodiments, the client 608 also includes client software 620. The client software 620 provides functionality to the client 608 that may be needed by the client device to execute one or more functions within the platform. The client software 620 may be implemented in various forms, for example, it may be in the form of a Java applet or program that is downloaded to the client 608 and runs in conjunction with the web browser 616. The client software 620 also may be in the form of a standalone application, implemented in a multi-platform language such as .Net or Java, or in native processor executable code. In one embodiment, if executing on the client 608, the client software 620 opens a network connection to the server 604 over the communications network 612 and communicates via that connection to the server 604. The client software 620 and the web browser 616 may be part of a single client-server interface 624; for example, the client software can be implemented as a “plug-in” to the web browser 616 and/or code that is downloaded and run within the framework of the web browser 616.

In one embodiment, the client software 620 is software that is specifically implemented for the purpose of implementing functions described herein. In another embodiment, the client software 620 includes other functionality, as well as implementing functions described here. For example, the client software 620 may be included as part of an operating system, application server, mobile application (or “app”), application program, and/or other software. The client software 620 may perform tests when other functions of such operating systems, application servers and/or application programs are not using the full capacity of the device.

A communications network 612 connects the clients 608 with the server 604. The communication may take place via any media such as standard telephone lines, LAN or WAN links (e.g., T1, T3, 56 kb, X.25), broadband connections (ISDN, Frame Relay, ATM), wireless links (802.11, Bluetooth, cellular, etc.), and so on, in any suitable combination. Preferably, the network 612 can carry TCP/IP protocol communications, and HTTP/HTTPS requests made by the web browser 316 and the connection between the client software 620 and the server 604 may be communicated over such TCP/IP networks. The type of network is not a limitation, however, and any suitable network may be used. Non-limiting examples of networks that can serve as or be part of the communications network 612 include a wireless or wired Ethernet-based intranet, a local or wide-area network (LAN or WAN), and/or the global communications network known as the Internet, which may accommodate many different communications media and protocols.

The servers 604 interact with clients 608. The server 604 is preferably implemented on one or more server class computers that have sufficient memory, data storage, and processing power and that run a server class operating system (e.g., SUN Solaris, GNU/Linux, and the MICROSOFT WINDOWS family of operating systems). Other types of system hardware and software than that described herein may also be used, depending on the capacity of the device and the number of users and the size of the user base. For example, the server 604 may be implemented on, or may be part of, a logical group of one or more servers such as a server farm or server network. As another example, there may be multiple servers 604 that may be associated or connected with each other, or multiple servers could operate independently, but with shared data. In a further embodiment and as is typical in large-scale systems, the application software may be implemented in components and/or subgroups, with different components and/or subgroups running on different server computers, on the same server, or some combination.

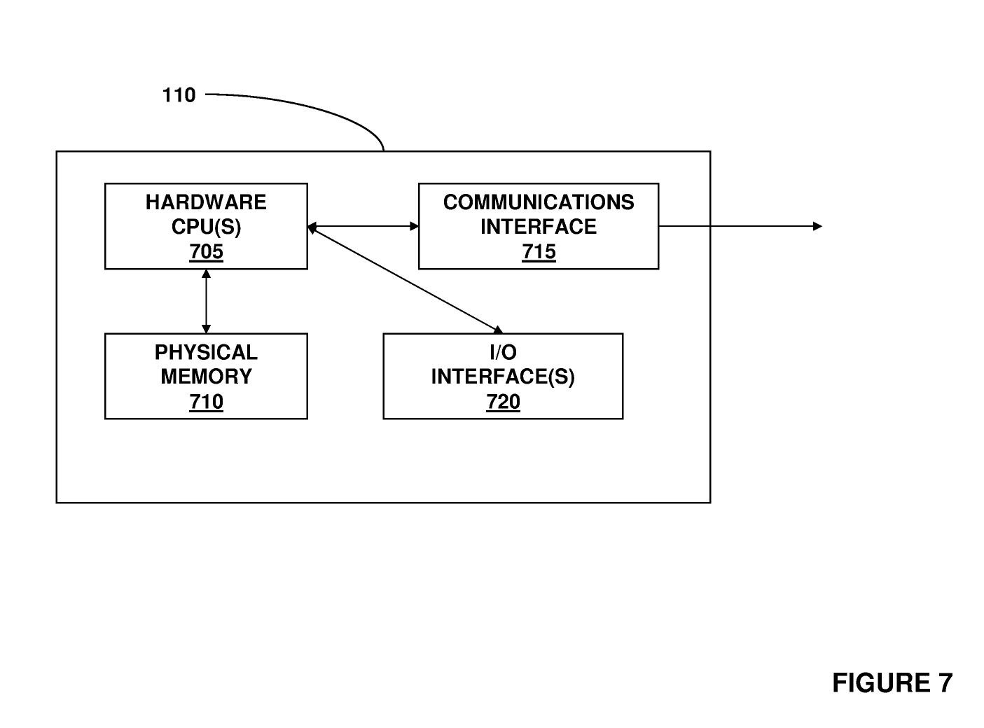

Referring to FIG. 7, those skilled in the art will appreciate that various implementations of the invention may be practiced with various computer system configurations, including hand-held wireless devices such as mobile phones or personal digital assistants (PDAs), multiprocessor systems, microprocessor-based or programmable consumer electronics, minicomputers, mainframe computers, and the like.

The invention may also be practiced in distributed computing environments where tasks are performed by remote processing devices that are linked through a communications network. In a distributed computing environment, program modules may be located in both local and remote computer storage media including memory storage devices.

In some cases, relational (or other structured) databases may provide data storage and management functionality, for example as a database management system or database server 610 which stores data related to the services and consumers utilizing the service. Examples of databases include the MySQL Database Server or ORACLE Database Server offered by ORACLE Corp. of Redwood Shores, Calif., the PostgreSQL Database Server by the PostgreSQL Global Development Group of Berkeley, Calif., or the DB2 Database Server offered by IBM.

The computer system may include a general purpose computing device 110 in the form of a computer including a processing unit 705, a system memory 710, and a system bus that couples various system components including the system memory to the processing unit.

Computers typically include a variety of computer readable media that can form part of the system memory 710 and be read by the processing unit 705. By way of example, and not limitation, computer readable media may comprise computer storage media and communication media. The system memory may include computer storage media in the form of volatile and/or nonvolatile memory such as read only memory (ROM) and random access memory (RAM). A basic input/output system (BIOS), containing the basic routines that help to transfer information between elements, such as during start-up, is typically stored in ROM. RAM typically contains data and/or program modules that are immediately accessible to and/or presently being operated on by processing unit. The data or program modules may include an operating system, application programs, other program modules, and program data. The operating system may be or include a variety of operating systems such as Microsoft Windows® operating system, the Unix operating system, the Linux operating system, the Xenix operating system, the IBM AIX™ operating system, the Hewlett Packard UX™ operating system, the Novell Netware™ operating system, the Sun Microsystems Solaris™ operating system, the OS/2™ operating system, or another operating system of platform.

At a minimum, the memory 710 includes at least one set of instructions that is either permanently or temporarily stored. The processor 705 executes the instructions that are stored in order to process data. The set of instructions may include various instructions that perform a particular task or tasks. Such a set of instructions for performing a particular task may be characterized as a program, software program, software, engine, module, component, mechanism, or tool.

The system may include a plurality of software processing modules stored in a memory as described above and executed on the platform 110. The program modules may be in the form of any suitable programming language, which is converted to machine language or object code to allow the processor or processors to read the instructions. That is, written lines of programming code or source code, in a particular programming language, may be converted to machine language using a compiler, assembler, or interpreter. The machine language may be binary coded machine instructions specific to a particular computer.

Any suitable programming language may be used in accordance with the various embodiments of the invention. Illustratively, the programming language used may include assembly language, Ada, APL, Basic, C, C++, COBOL, dBase, Forth, FORTRAN, Java, Modula-2, Pascal, Prolog, REXX, and/or JavaScript, for example. Further, it is not necessary that a single type of instruction or programming language be utilized in conjunction with the operation of the system and method of the invention. Rather, any number of different programming languages may be utilized as is necessary or desirable.

The computing environment may also include other removable/non-removable, volatile/nonvolatile computer storage media. For example, a hard disk drive may read or write to non-removable, nonvolatile magnetic media. A magnetic disk drive may read from or writes to a removable, nonvolatile magnetic disk, and an optical disk drive may read from or write to a removable, nonvolatile optical disk such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The storage media are typically connected to the system bus through a removable or non-removable memory interface.

The processing unit that executes commands and instructions may be a general purpose computer, but may utilize any of a wide variety of other technologies including a special purpose computer, a microcomputer, mini-computer, mainframe computer, programmed micro-processor, micro-controller, peripheral integrated circuit element, a CSIC (Customer Specific Integrated Circuit), ASIC (Application Specific Integrated Circuit), a logic circuit, a digital signal processor, a programmable logic device such as an FPGA (Field Programmable Gate Array), PLD (Programmable Logic Device), PLA (Programmable Logic Array), RFID integrated circuits, smart chip, or any other device or arrangement of devices that is capable of implementing the steps of the processes of the invention.

It should be appreciated that the processors and/or memories of the computer system need not be physically in the same location. Each of the processors and each of the memories used by the computer system may be in geographically distinct locations and be connected so as to communicate with each other in any suitable manner via, for example, a communications interface 715. Additionally, it is appreciated that each of the processor and/or memory may be composed of different physical pieces of equipment.

A user may enter commands and information into the computer through one or more user device interfaces 720 that communicate with input devices such as a keyboard and pointing device, commonly referred to as a mouse, trackball or touch pad. Other input devices may include a microphone, joystick, game pad, satellite dish, scanner, voice recognition device, keyboard, touch screen, toggle switch, pushbutton, or the like. These and other input devices are often connected to the processing unit through a user input interface that is coupled to the system bus, but may be connected by other interface and bus structures, such as a parallel port, game port or a universal serial bus (USB).

One or more monitors or display devices (not shown) may also be connected to the system bus via an interface. In addition to display devices, computers may also include other peripheral output devices, which may be connected through an output peripheral interface. The computers implementing the invention may operate in a networked environment using logical connections to one or more remote computers, the remote computers typically including many or all of the elements described above.

Although internal components of the computer are not shown, those of ordinary skill in the art will appreciate that such components and the interconnections are well known. Accordingly, additional details concerning the internal construction of the computer need not be disclosed in connection with the present invention.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, define, in part, the scope of the foregoing claim terminology.

What is claimed is:

1. A computer-implemented method for delivering an offer to a consumer, the method comprising the steps of:
providing electronic access to a promotions server on which computer-executable instructions are stored, that, when executed, allow a merchant to design and distribute an offer to consumers, wherein designing the offer comprises:
selecting, by the merchant, one or more offer parameters and one or more offer delivery outlets; and
wherein distributing the offer comprises:
effecting the transmission of the offer to one or more consumers and receiving, from a subset of the one or more consumers, acceptance of the offer.

2. The method of claim 1 wherein the offer comprises a discount on a consumer good.

3. The method of claim 1 wherein the offer comprises a discount on a service.

4. The method of claim 1 wherein the offer parameters comprise one or more of an offer time, a product, a service, a price, a discount, an audience for the offer, or a redemption location.

5. The method of claim 4 wherein one or more of the offer parameters are automatically generated by the promotions server and suggested to the merchant.

6. The method of claim 5 wherein the offer parameters are automatically generated based at least in part on offer parameters used in previously designed offers.

7. The method of claim 6 wherein the offer parameters used in previously designed offers were offers designed by the merchant.

8. The method of claim 6 wherein the offer parameters used in previously designed offers were offers designed by a merchant other than the merchant.

9. The method of claim 5 further comprising facilitating the modification of one or more of the automatically generated offer parameters by the merchant.

10. The method of claim 1 further comprising, upon receipt of an acceptance of the offer, fulfilling the offer and transmitting confirmation of the acceptance to the subset of the one or more consumers.

11. A system for delivering an offer to a consumer, the system comprising:
a processor for executing computer-executable instructions; and
a memory for storing computer-executable instructions, that when executed by the processor provides access to a promotions server on which a merchant designs and distributes an offer to consumers, wherein designing the offer comprises selecting, by the merchant (a) one or more offer parameters and (b) one or more offer delivery outlets and wherein distributing the offer comprises (i) effecting the transmission of the offer to one or more consumers and (ii) receiving, from a subset of the one or more consumers, acceptance of the offer.

12. The system of claim 11 wherein the computer-executable instructions further implement a feedback module that when executed automatically generate one or more of the offer parameters suggest such parameters to the merchant for inclusion in the offer.

13. The system of claim 12 further comprising a data storage module that stores offer parameters of historical offers and wherein the computer-executable instructions automatically generate the offer parameters based at least in part on the offer parameters of historical offers.

14. The system of claim 13 wherein the offer parameters used in previously designed offers were offers designed by the merchant.

15. The system of claim 13 wherein the offer parameters used in previously designed offers were offers designed by a merchant other than the merchant.
